(19) United States
(12) Patent Application Publication
(10) Pub. No.: US 2013/0073357 A1
(43) Pub. Date: Mar. 21, 2013

(54) BASELESS TOKEN USER INTERACTION INCENTIVE SYSTEM, METHOD, AND APPARATUS

(71) Applicant: Andrew Gillibrand, Rosebank (ZA)

(72) Inventor: Andrew Gillibrand, Rosebank (ZA)

(73) Assignee: Click Science Corporation US, New York, NY (US)

(21) Appl. No.: 13/233,666

(22) Filed: Sep. 15, 2011

(51) Int. Cl. G06Q 30/00

(52) U.S. Cl. 705/14.11

(57) ABSTRACT

A system, methods, and apparatus for facilitating a user interaction using baseless tokens are disclosed. In an example embodiment, a campaign is purchased by a campaign ruler from a campaign administrator for a cost that includes a rebate amount allocated to a rebate account. A set of rules for creation is received from the campaign ruler defining interactions with corresponding baseless token awards. A set of rules for destruction is received from the campaign ruler defining interactions such as participation in an auction with corresponding destruction of baseless tokens. Users are awarded baseless tokens which are redeemable only through a right of participation, and baseless tokens are destroyed based on user participation. A prize is delivered to a winning user. A rebate is provided to the campaign ruler for delivery of the prize, from the rebate account, which is maintained independently of baseless token creation and destruction.

### BACKGROUND

Traditional marketing, advertising, and information distribution techniques have been evolving with the recent technological advances that allow for greater use of electronic media and communication. For example, in recent years, internet based advertising campaign techniques relating to sponsored search results, targeted advertising, social media marketing, viral video advertising, and the like have increased in popularity, with internet advertising revenues reportedly surpassing billions of dollars per year.

Many companies may have significant marketing budgets relating to advertising particular products, special sales offers, store locations, brand recognition, and/or providing public service announcements. Typically, a company may diversify its advertising budget between internet based media, such as banner advertisements, interstitial advertisements, sponsored links, online rewards points, social networking advertisements, advertising email, and with more traditional media forms as well, such as radio and television commercials, billboards, newspaper advertisements, loyalty programs, membership rewards, and/or advertising mail. These advertisements may include special offers, coupons, prizes, rewards points, and the like to induce a recipient of the message to perform some action, such as purchase a product being advertised. Typically, significant efforts are expended in attempting to optimally allocate marketing funds to maximize results. For example, a company may implement a rewards program, but may have a difficult time setting the amount of rewards, because greater rewards will eventually have diminishing returns. Similarly, for example, a company may serve targeted advertisements via the internet using a variety of channels and monitor results, such as click through rates. However, when large masses of advertisers are providing content to users, it is difficult to stand out to the users, without giving away too much of a reward (e.g., a very large coupon discount), and without spending large amounts of marketing funds. Accordingly, despite the various options available for performing a campaign, many companies still find difficulty in optimally allocating marketing funds, likely because it is often difficult to accurately place a value on each interaction or impression generated by a particular piece of content, such as an advertisement, a coupon, or reward.

### SUMMARY

The present disclosure provides a new and innovative system, methods and apparatus for facilitating a user interaction using baseless tokens. In an example embodiment, a campaign is purchased by a campaign ruler from a campaign administrator for a cost that includes a rebate amount allocated to a rebate account. A set of rules for creation is received from the campaign ruler defining interactions with corresponding baseless token awards. A set of rules for destruction is received from the campaign ruler defining interactions such as participation in an auction with corresponding destruction of baseless tokens. Users are awarded baseless tokens which are redeemable only through a right of participation, and baseless tokens are destroyed based on user participation. A prize is delivered to a winning user. A rebate is provided to the campaign ruler for delivery of the prize, from the rebate account, which is maintained independently of baseless token creation and destruction.

Additional features and advantages of the disclosed method and apparatus are described in, and will be apparent from, the following Detailed Description and the Figures.

### BRIEF DESCRIPTION OF THE FIGURES

FIG. 1 is a high level block diagram of an example network communicating system, according to an example embodiment of the present invention.

FIG. 2 is a detailed block diagram showing an example of a computing device, according to an example embodiment of the present invention.

FIG. 3 provides a block diagram showing an example baseless token network structure, according to an example embodiment of the present invention.

FIG. 4 is a flowchart illustrating an example process for facilitating a user interaction using baseless tokens, according to an example embodiment of the present invention.

FIG. 5 is a block diagram showing an example data architecture, according to an example embodiment of the present invention.

### DETAILED DESCRIPTION OF EXAMPLE EMBODIMENTS

The present disclosure relates in general to a system for facilitating user interactions and, in particular, a baseless token user interaction incentive. Briefly, in an example embodiment, a system is provided which allows an action-based marketing platform that enables an advertiser to run online campaigns and reward its users for performing specific actions within its website in real time. For example, an advertiser may be a shoe company that wants to take users on a journey through its website. In this example embodiment, a campaign may be priced based on the popularity of the shoe company's website, the duration of the campaign, and the amount of baseless tokens awarded for interactions in the user's journey. Users may find the shoe company's campaign in the results page of a search engine or through social media. When users perform the interactions of the shoe company's journey, the user receive baseless tokens for completing the interactions. When the shoe company purchases the campaign, a portion of the price is allocated to their rebate account as a rebate. The users may use the baseless tokens to win a pair of shoes that the shoe company has put up for auction. The shoe company delivers the shoes to the winning user and receives the rebate which was allocated to the rebate account. The baseless tokens are created for users when they perform the interactions along the journey as specified by the shoe company, and the baseless tokens used to win the auction are destroyed when the auction ends. The shoe company has delivered a pair of shoes to the users and the users have explored the shoe company's website, taking a guided journey that results in a longer period of interaction and higher quality interaction. Accordingly, the shoe company is able to break through the typical internet advertising clutter and induce users to deeply engage the content according to the campaign. Moreover, the shoe company may provide the baseless tokens as a marginal incentive for user interaction. In a non-limiting example embodiment, certain features disclosed in the present patent application may be commercially embodied in products and services offered by Click Science Corporation US, the assignee of the present application.

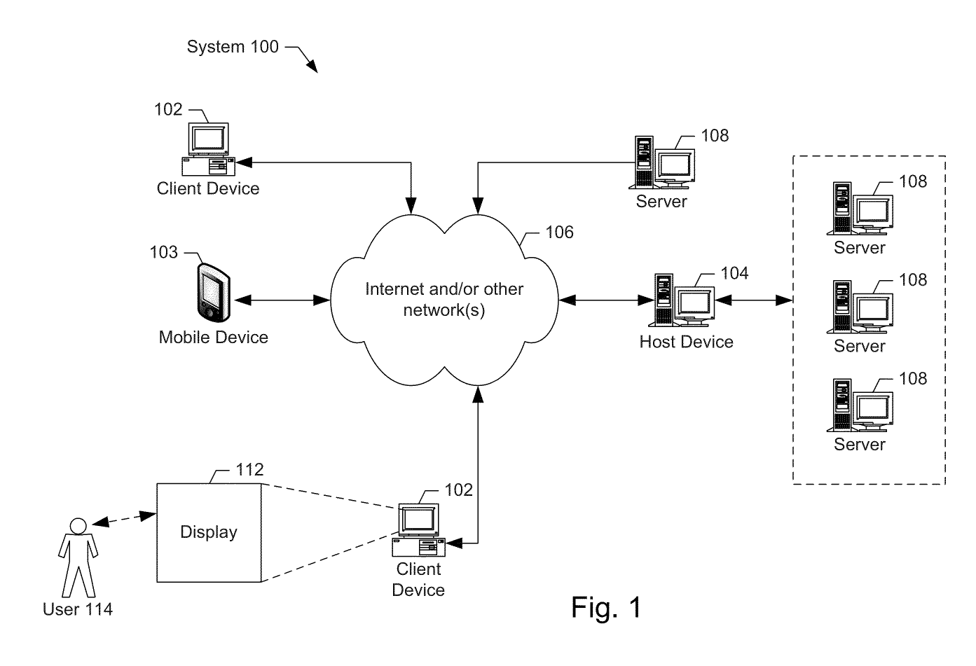

The present system may be readily realized in a network communications system. A high level block diagram of an example network communications system 100 is illustrated in FIG. 1. The illustrated system 100 includes one or more client devices 102, and one or more host devices 104. The system 100 may include a variety of client devices 102, such as desktop computers and the like, which typically include a display 112, which is a user display for providing information to users 114, and various interface elements as will be discussed in further detail below. A client device 102 may be a mobile device 103, which may be a cellular phone, a personal digital assistant, a laptop computer, a tablet computer, etc. The client devices 102 may communicate with the host device 104 via a connection to one or more communications channels 106 such as the Internet or some other data network, including, but not limited to, any suitable wide area network or local area network. It should be appreciated that any of the devices described herein may be directly connected to each other instead of over a network. Typically, one or more servers 108 may be part of the network communications system 100, and may communicate with host servers 104 and client devices 102.

One host device 104 may interact with a large number of users 114 at a plurality of different client devices 102. Accordingly, each host device 104 is typically a high end computer with a large storage capacity, one or more fast microprocessors, and one or more high speed network connections. Conversely, relative to a typical host device 104, each client device 102 typically includes less storage capacity, a single microprocessor, and a single network connection. It should be appreciated that a user 114 as described herein may include any person or entity which uses the presently disclosed system and may include a wide variety of parties. For example, as will be discussed in further detail below, users 114 of the presently disclosed system may include a campaign administrator, a campaign ruler, and/or an end user or consumer, which will often be referred to simply as a user in the present disclosure. The present disclosure may specifically refer to a user 114 as a campaign administrator, a campaign ruler, or end user when the particular type of user 114 is particularly pertinent for an exemplary disclosure.

Typically, host devices 104 and servers 108 store one or more of a plurality of files, programs, databases, web applications, and/or web pages in one or more memories for use by the client devices 102, and/or other host devices 104 or servers 108. A host device 104 or server 108 may be configured according to its particular operating system, applications, memory, hardware, etc., and may provide various options for managing the execution of the programs and applications, as well as various administrative tasks. A host device 104 or server may interact via one or more networks with one or more other host devices 104 or servers 108, which may be operated independently. For example, host devices 104 and servers 108 operated by a separate and distinct entities may interact together according to some agreed upon protocol.

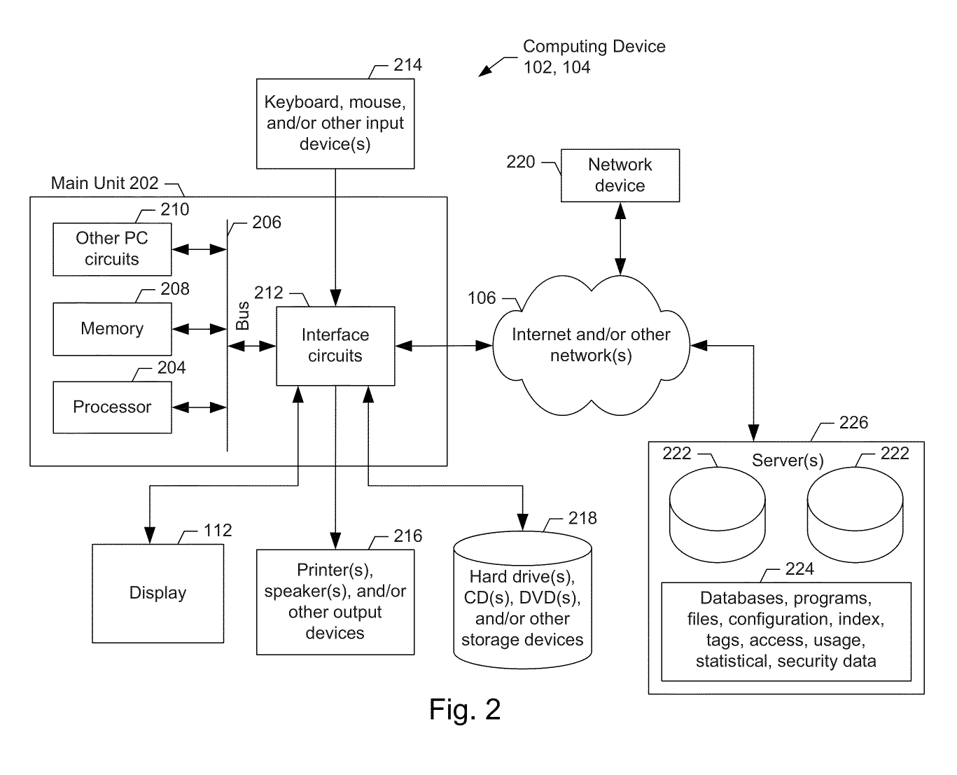

A detailed block diagram of the electrical systems of an example computing device (e.g., a client device 102, and a host device 104) is illustrated in FIG. 2. In this example, the computing device 102, 104 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with the other devices in the system 100 as described below. This program may be executed by the processor 204 in any suitable manner. In an example embodiment, memory 208 may be part of a “cloud” such that cloud computing may be utilized by a computing devices 102, 104. The memory 208 may also store digital data indicative of documents, files, programs, web applications, web pages, etc. retrieved from a computing device 102, 104 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, image sensor, character recognition, barcode scanner, microphone, and/or a voice recognition system.

One or more displays 112, printers, speakers, and/or other output devices 216 may also be connected to the main unit 202 via the interface circuit 212. The display 112 may be a cathode ray tube (CRTs), a liquid crystal display (LCD), or any other type of display. The display 112 generates visual displays generated during operation of the computing device 102, 104. For example, the display 112 may provide a user interface, which will be described in further detail below, and may display one or more web pages received from a computing device 102, 104. A user interface may include prompts for human input from a user 114 including links, buttons, tabs, checkboxes, thumbnails, text fields, drop down boxes, etc., and may provide various outputs in response to the user inputs, such as text, still images, videos, audio, and animations.

One or more storage devices 218 may also be connected to the main unit 202 via the interface circuit 212. For example, a hard drive, CD drive, DVD drive, and/or other storage devices may be connected to the main unit 202. The storage devices 218 may store any type of data, such as pricing data, campaign data, baseless token account data, rebate data, image data, video data, audio data, historical access or usage data, statistical data, security data, etc., which may be used by the computing device 102, 104.

The computing device 102, 104 may also exchange data with other network devices 220 via a connection to the network 106. Network devices 220 may include one or more servers 226, which may be used to store certain types of data, and particularly large volumes of data which may be stored in one or more data repository 222. A server 226 may include any kind of data 224 including databases, programs, applications, files, index, tags, libraries, pricing data, campaign data, baseless token account data, rebate data, configuration data, index data, historical access or usage data, statistical data, security data, etc. A server 226 may store and operate various applications relating to receiving, transmitting, processing, and storing the large volumes of data. It should be appreciated that various configurations of one or more servers 226 may be used to support and maintain the system 100. For example, servers 226 may be operated by various different entities, including a campaign administrator, a financial account entity, an advertising company, etc. Also, certain data may be stored in a client device 102 which is also stored on the server 226, either temporarily or permanently, for example in memory 208 or storage device 218. The network connection may be any type of network connection, such as an Ethernet connection, digital subscriber line (DSL), telephone line, coaxial cable, wireless connection, etc.

Access to a computing device 102, 104 can be controlled by appropriate security software or security measures. Users' 114 access can be defined by the computing device 102, 104 and limited to certain data and/or actions. Accordingly, users 114 of the system 100 may be required to register with one or more computing devices 102, 104. For example, registered users 114 may be able to request or manipulate data, such as reviewing campaign information or reports, negotiating pricing, purchase campaigns, and/or receive rebates.

As noted previously, various options for managing data located within the computing device 102, 104 and/or in a server 226 may be implemented. A management system may manage security of data and accomplish various tasks such as facilitating a data backup process. A management system may be implemented in a client 102, a host device 104, and a server 226. The management system may update, store, and back up data locally and/or remotely. A management system may remotely store data using any suitable method of data transmission, such as via the Internet and/or other networks 106.

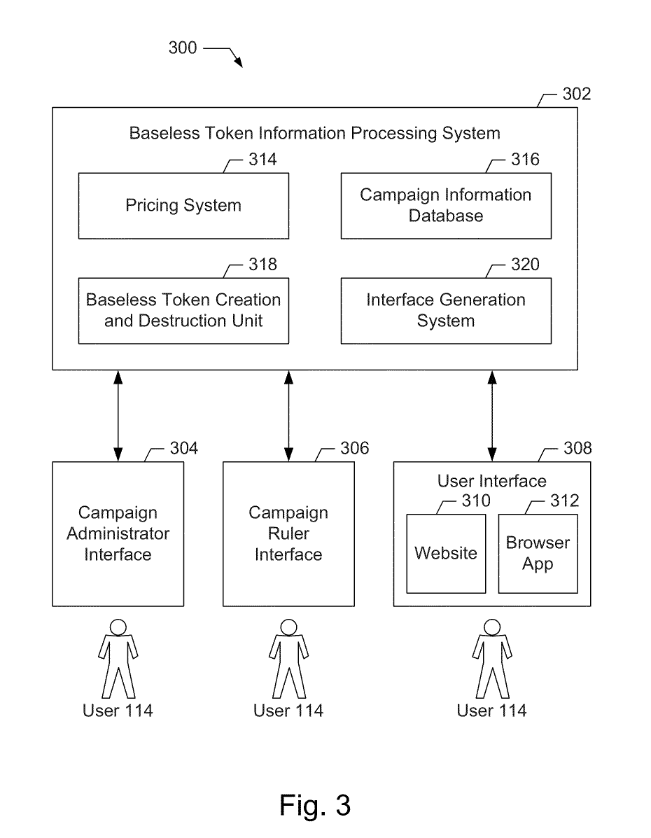

FIG. 3 provides a block diagram showing an example baseless token network structure 300. As illustrated in FIG. 3, the example baseless token network structure 300 includes an baseless token information processing system 302, a campaign administrator interface 304, a campaign ruler interface 306, and a user interface 308, which may include a website 310 and a browser application 312. The example baseless token information processing system 302 may be implemented on one or more host devices 104 accessing one or more servers 108, 226. In an example embodiment, the baseless token information processing system 302 includes a pricing system 314, a campaign information database 316, a baseless token creation and destruction unit 318, and an interface generation system 320. A user 114 may be a campaign administrator, a campaign ruler, or an end user that interacts with the campaign administrator interface 304, a campaign ruler interface 306, and/or a user interface 308, respectively. In an example embodiment, a campaign administrator may be responsible for administration of the baseless token information processing system 302, which may include providing for the creation and destruction of baseless tokens. The campaign administrator may be a marketing company and any person, employee, agent, or computer program acting on its behalf may be referred to as a campaign administrator within the present disclosure. A campaign ruler may be any party which causes a campaign to be run by the campaign administrator, and again, any person, employee, agent, or computer program acting on a campaign ruler's behalf may be referred to as a campaign ruler within the present disclosure. A user 114 may be any person or entity that receives campaign content or information from the baseless token information processing system 302, and typically, is a existing or prospective customer, subscriber, or the like of a campaign ruler. Accordingly, for example, a campaign ruler may purchase an advertising campaign from a campaign administrator, which will administer the advertising campaign to the end users. It should be appreciated that content or information that is distributed may typically consist of advertisements, but that any type of content or information may be provided in a campaign. For exemplary purposes, the present disclosure may specifically refer to an advertising campaign.

In an example embodiment, a campaign administrator interface 304 may allow a campaign administrator to perform any activities required to operate the baseless token information processing system 302. The campaign administrator may be referred to or known as a system manager, system operator, or campaign operator, and may be, for example, a marketing company, such as an internet advertising company. The campaign administrator interface 304 allows the campaign administrator to, for example, set pricing schedules for campaigns, analyze campaign and pricing success rates, revenue, profitability, etc. For example, a user 114 input a request for the campaign administrator interface 304 to perform an analysis on user interaction rates of previous campaigns. Also, the campaign administrator interface 304 may be used for negotiating campaigns, for example, during negotiations with large campaign rulers for a large campaign of significant volume and/or duration. Further, the campaign administrator interface 304 may be used for promotional or marketing purposes of promoting the baseless token information processing system 302 to users 114, including campaign rulers and end users. For example, self-promotional campaigns may be run to increase the universe of system users 114. System features such as standard or custom user interactions available for campaigns may be changed or updated, improved security features may be added, and general system maintenance may be performed by a campaign administrator via campaign administrator interface 304.

In an example embodiment, a campaign ruler interface 306 allows a campaign ruler, such as an advertiser, to purchase a campaign. For example, the advertiser may input various campaign parameters and receive a price quote, which the advertiser may accept and purchase or modify the parameters. In an example embodiment, a basic campaign provides a campaign ruler or advertiser with an introduction to the baseless token information processing system 302. A basic campaign may include, for example, a single interaction such as a page load, provide one baseless token per unique interaction, and cost $5. In an example embodiment, the campaign ruler interface 306 requests an advertiser to provide information such as the current average daily number of hits to its website. A basic campaign may be priced based on this simple information. For example, a campaign ruler with a small website with light traffic may pay more than a campaign ruler with a website with heavy traffic when each requests a basic campaign with standard pricing. For large campaign ruler accounts, the campaign ruler interface 306 may allow pricing terms may be negotiated, reports may be run for previous campaign success, interaction rates, etc., and various other features may be available. When a campaign ruler is purchasing a campaign, a wide variety of interaction parameters may be available. The interaction parameters may include rules for creation and rules for destruction, which specify interactions for creating baseless tokens (e.g., page load, video completion) as well as interactions for destroying baseless tokens (e.g., provide an auction of a product). A campaign ruler interface 306 may allow for selection of all parameters for a campaign at the time of purchase, or may allow for deferring selection of certain parameters. For example, a campaign ruler may not be required to select certain parameters relating to a date and time of a product auction. In an example embodiment, a campaign ruler interface 306 may be provided at the campaign administrator's website.

In an example embodiment, a user interface 308 is used by users to collect baseless tokens for performing specified interactions and to use baseless tokens to receive prizes. The user interface 308 may include a website 310, which may be the campaign administrator's website. For example, the website 310 may provide information about the benefits of the system to the user, may explain how to start receiving awards, and may provide a download of an application or the like for the user 114 to install at the user interface 308. For example, a browser application 312 may be downloaded by a user free of charge and installed locally at the user interface 308. The browser application 312 may be an always-on application, a plug-in, add-on, tablet application, smartphone application, and/or dumbphone application, which resides on the user interface 308 and recognizes websites that are running campaigns and allows for baseless tokens to be provided when interactions are performed by the user 114. In an example embodiment the browser application 312 may be less intrusive than a typical toolbar, providing minimal information so as to not obstruct or interfere with the user's 114 normal browsing activities. For example, a user 114 may perform an internet search which results in a page of results, some of which display an icon or badge indicating that baseless tokens are available for the user to obtain. For example, the user may hover over a badge next to a link which causes a pop-up box to appear, which provides information including the number of baseless tokens that may be awarded for completion of interactions specified in the campaign, information about the content, etc. In an example embodiment, the browser application 312 may provide a toolbar which displays or provides a link to the number of baseless tokens available at a website, a user's 114 baseless token account balance, a user's 114 current bids and auctions of interest, etc. Accordingly, in an example embodiment, for users 114 of the baseless token information processing system 302, the user interface 308 may include any website 310 which has a campaign running, in conjunction with the browser application 312. The user interface 308 may provide and/or direct users to qualifying user interactions via the browser application 312 and/or through the campaign administrator's website 310. The user interface 308 may direct users 114 to auctions, contests, and/or games where the baseless tokens may be used. Also, the user interface 308 may provide detailed user account information, such as an account balance, an interaction history, etc. Further, in an example embodiment, the user interface 308 may be provided on a users' 114 mobile device 103.

In an example embodiment, a pricing system 314 uses a wide variety of pricing data to provide pricing information for prospective and existing campaigns. For example, standard pricing schedules or guidelines may be provided for standard campaigns. Various factors may affect the price of a campaign, including the popularity of the campaign ruler's website, the duration of the campaign, the number and type of interactions and the amount of baseless tokens awarded for the interactions, and the number of users 114 of the baseless token information processing system 302. In an example embodiment, the pricing system 314 may use a campaign ruler's inputs to provide a provide a campaign price based on standard prices for the features desired by the campaign ruler. The pricing system may be used to provide quotes for a customized campaign. Also, the pricing system 314 may provide analysis or reports relating to any special pricing, such as pricing which may be requested for large accounts or a long term campaign engagement.

In an example embodiment, a campaign information database 316 stores a wide variety of campaign data, such as pricing data, interaction data, success and/or effectiveness data, token creation and destruction data, user activity, feedback from users and campaign rulers, rebate data, prize data, etc., including current data, raw data, statistical data and/or historical data. In an example embodiment, real-time baseless token account data is stored for each user 114. Virtually any data that may be used by the baseless token information processing system 302 for managing accounts, setting pricing schedules, determining baseless token awards, or any analysis and/or report preparation may be stored in a campaign information database 316.

In an example embodiment, a baseless token creation and destruction unit 318 analyzes user interaction data according to the rules of creation and rules of destruction specified by a campaign ruler. For example, a campaign's rules for creation may specify a page load for the creation of one baseless token and completion of a video for the creation of five baseless tokens. The baseless token creation and destruction unit 318 may receive data from the user interface 308 which is analyzed to determine whether the interactions specified in the rules for creation have been performed, and then may award a one baseless token for a page load or six baseless tokens for a page load and video completion to the user's account in any order or a in a specific order. The baseless token creation and destruction unit 318 may analyze auctions, games, and contests to determine if rules for destruction are met, and may destroy the specified number of baseless tokens from the appropriate user's 114 baseless token account.

In an example embodiment, an interface generation unit 320 may provide, for example, HTML files, toolbar data, baseless token icons, or the like, which are used at the campaign administrator interface 304, campaign ruler interface 306, and user interface 308 to provide information to the respective users 114. The interface generation unit 320 may have different settings which may be employed by a campaign administrator, a campaign ruler, and/or a user 114, to provide a customized appearance of the campaign administrator interface 304, the campaign ruler interface 306, and/or the user interface 308. For example, a user 114 may desire the user interface 308 provide only minimal baseless token information, so a toolbar, a widget, or the like may not be displayed, or the user may want the user interface 308 to provide an increased level of baseless token information, which may be provided in a toolbar, widget, add-on, badge, icons, and/or any other suitable module.

It should be appreciated that the campaign administrator interface 304, campaign ruler interface 306, and user interface 308 may be considered to be part of the baseless token information processing system 302, however, for discussion purposes, campaign administrator interface 304, campaign ruler interface 306, and user interface 308 may be referred to specifically or separately from the baseless token information processing system 302. It should also be appreciated that certain functions described as performed, for example, at the baseless token information processing system 302, may instead be performed locally at a campaign administrator interface 304, a campaign ruler interface 306, and a user interface 308, or vice versa. Further, in certain cases, tasks may be performed using a campaign administrator interface 304, a campaign ruler interface 306, and a user interface 308 or, for example, performed in person, such as negotiating the terms of a very large advertising campaign with a large, high-volume, advertiser. It should be appreciated that the campaign administrator interface 304, a campaign ruler interface 306, and/or a user interface 308 may be implemented, for example, in a web browser using a web browser application and an HTML file received from the baseless token information processing system 302. In an example embodiment, the campaign administrator interface 304, campaign ruler interface 306, and user interface 308 may be implemented as a secure website. Also, a campaign administrator interface 304 and/or a campaign ruler interface 306 may require a local application, for example, for access to account information.

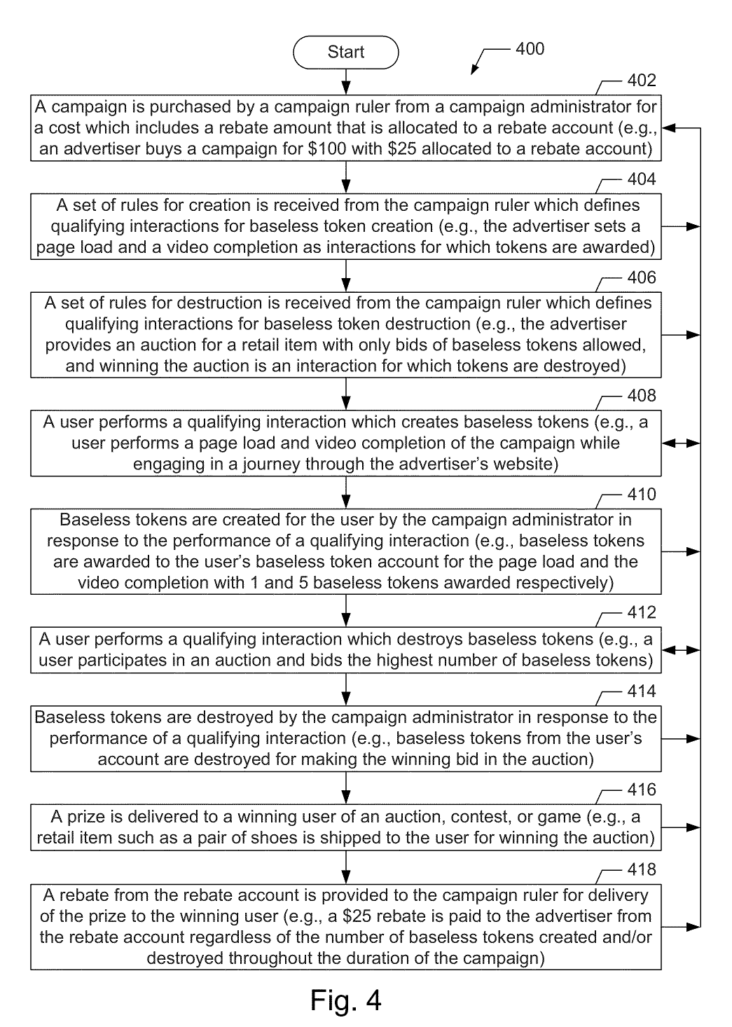

FIG. 4 is a flowchart of an example process 400 for facilitating a user interaction using baseless tokens. Although the process 400 is described with reference to the flowchart illustrated in FIG. 4, it will be appreciated that many other methods of performing the acts associated with the process 400 may be used. For example, the order of many of the blocks may be changed, certain blocks may be combined with other blocks, and many of the blocks described are optional.

The example process 400 may begin with a campaign ruler purchasing a campaign from a campaign administrator for a cost which includes a rebate amount that is allocated to a rebate account (block 402). For example, an advertiser buys a campaign for $100 with $25 allocated to a rebate account. The campaign may be a basic campaign with a standard price and rebate allocation. However, the terms of a campaign, including for example, pricing, interactions, and rebate allocation may depend on a wide variety of factors. In an example embodiment, when a campaign is purchased, a campaign ruler does not need to make any modifications to the website. Accordingly, purchasing a campaign may be very easy for advertisers that want to market a product, for example, using a web form on the campaign ruler interface 306.

A set of rules for creation is received from the campaign ruler which defines qualifying interactions for baseless token creation (block 404). For example, the advertiser sets a page load and a video completion as interactions for which tokens are awarded. The set of rules for creation may be received as a data file including all the information necessary to define the rules for creation. Also, the set of rules for creation may be received as an indication of a selection, such as a check box for a default campaign or a re-use of the rules for creation of a pre-existing campaign. Accordingly, for the purposes of explaining the present disclosure, the baseless token information processing system 302 may receive data actually indicating a set of rules (e.g., selections from drop down lists, checkboxes, radio buttons, text boxes, etc.) or simply a selection indicating a preexisting set of rules, such as a default setting, which may be stored in the system and not transmitted with each selection of the default setting. The campaign ruler may be able to provide inputs setting a wide variety of interactions as meeting the rules for creation, and if the campaign ruler interface 306 does not provide an option, a customized campaign may be requested. An example list of choices of qualifying interactions provided to a campaign ruler may include a page load, a purchase, a subscription, a sign-up, a survey completion, a video completion, a download, a vote, a check-in, a link click, and/or a button click. Accordingly, for example, an interaction may not need to be performed in a website. An example of an interaction performed outside of a website would be a check-in at a specific location, for example, where a mobile device 103 may check-in by taking a picture of a landmark or using GPS to indicate the user's geolocation. Virtually any type of digital interaction may be used as a qualifying interaction, as long as the baseless token information processing system 302 can detect the interaction. It should be appreciated that the type of interaction a campaign ruler specifies may change the cost of the campaign. As discussed in more detail below, a simple link click or page load may be priced lower than a video completion, a purchase, or a subscription, for example. In an example embodiment, a campaign ruler selects qualifying interactions for the rules of creation which take a user through the campaign ruler's website as the user performs the interactions.

A set of rules for destruction is received from the campaign ruler which defines qualifying interactions for baseless token destruction (block 406). For example, the advertiser provides an auction for a retail item with only bids of baseless tokens allowed, and winning the auction is an interaction for which tokens are destroyed. Accordingly, bids of other types, such as money bids, are not accepted in the auction. In an example embodiment, a campaign ruler selects qualifying interactions for the rules of destruction that further a user's journey. For example, the campaign ruler may tailor the rules for destruction to advertising the campaign ruler's brand or a new product line. In an example embodiment, a video game manufacturer may specify that the qualifying interaction is making a difficult or uncommon play in a new video game such as a baseball game. Accordingly, the user may continue his journey while performing the interaction specified by the rules for destruction.

A user performs a qualifying interaction which creates baseless tokens (block 408). For example, a user performs a page load and video completion of the campaign while engaging in a journey through the advertiser's website. As discussed above, a user may perform a search, and in the search results be presented with a baseless token icon indicating that baseless tokens are available at particular website. The user may be induced to go to the website where the baseless tokens are available, as opposed to a different website which does not provide baseless tokens. The baseless token information processing system 302 may provide a very broad reach throughout internet search because a website may offer baseless tokens through all of the large search engines (e.g., Google, Bing, Yahoo, Baidu) and/or social media (e.g., Facebook, Twitter, LinkedIn). Although websites for current campaigns may be found at the campaign administrator website, internet search may significantly broaden the number of users finding the campaigns offering baseless tokens. Also, a qualifying user interaction may be limited to unique interactions, so that users cannot repeat the interaction multiple times and receive additional baseless tokens with each repeated interaction.

Then, baseless tokens are created for the user by the campaign administrator in response to the performance of a qualifying interaction (block 410). For example, baseless tokens are awarded to the user's baseless token account for the page load and the video completion with one and five baseless tokens awarded respectively. The user's baseless token account may be maintained at the baseless token information processing system 302 and/or locally at the user interface 308, for example, on the browser application 312. Once a user is awarded baseless tokens, the user's account balance may update in real time so the user can see the rewards provided and decide to use the baseless tokens. It should be appreciated that when tokens are created by the baseless token information processing system 302, the baseless tokens may exist only as virtual tokens, and may exist only at a user interface 310, for example, in a browser application 312. In an example embodiment, the baseless token information processing system 302 does not keep an accounting of how many baseless tokens are outstanding because the number of outstanding baseless tokens does not impose any liability, contingent or non-contingent, on either the campaign administrator or the campaign rulers. In an example embodiment, the baseless token information processing system 302 may create an unlimited number of baseless tokens.

A user performs a qualifying interaction which destroys baseless tokens (block 412). For example, a user participates in an auction and bids the highest number of baseless tokens. For example, a bid of 101 baseless tokens may be the highest bid for an auction for a retail item such as a pair of shoes. In an example embodiment, baseless token auctions may be presented via user interface 308 on the campaign administrator's website and/or on the campaign ruler's website. In an example embodiment, a wide variety of auctions, contests, and/or games may be qualifying interactions which meets the rules for destruction. For example, quizzes, board games, trivia questions, games of chance, skill games, video games, etc., may be participated in by users, where one or more winners are determined. Accordingly, a winner of an auction, contest, and/or game may be selected completely at random (e.g., a roll of the dice), determined without any randomness at all (e.g., a skill game), or determined through some degree of randomness. In an example embodiment, mathematical calculations are performed, with the user completing the questions fastest winning. A variety of auctions of different styles may be used to determine a winner of an auction (e.g., open auction, silent auction, vickrey auction). In an example embodiment, a qualifying interaction may be specified as a user hitting a grand slam while playing a promotional version of a new video game. Accordingly, a user taking a journey through a video game manufacturer website may be able to collect baseless tokens by performing interactions according to the rules for creation and continue on the journey while performing an interaction according to the rules for destruction.

Then, baseless tokens are destroyed by the campaign administrator in response to the performance of a qualifying interaction (block 414). For example, baseless tokens from the user's account are destroyed for making the winning bid in the auction. For example, the bid of 101 baseless tokens was the highest bid of the auction, so 101 baseless tokens may be destroyed from the user's baseless token account. In the example embodiment, until after the user bids 101 baseless tokens and wins the auction, the user did not know that the bid of 101 tokens would win the auction. Moreover, in the example embodiment, no predetermined exchange schedule sets a price, rather, the bid of 101, which was not certain to win the auction until the auction closed or concluded, was determined to be the qualifying interaction according to the rules for destruction. Accordingly, 101 baseless tokens must be destroyed based on that qualifying interaction as specified by the campaign ruler or advertiser. It should be appreciated that if the user did not have 101 baseless tokens available in their account, the bid may not be accepted as the winning bid. The user's baseless token account may be updated in real time if baseless tokens are destroyed by the user interaction. In an example embodiment, another auction with the same prize conducted, which closed at a later time during the day may have a winning bid of 1,000 baseless tokens.

Next, a prize is delivered to a winning user of an auction, contest, or game (block 416). For example, a retail item such as a pair of shoes is shipped to the user for winning the auction. The campaign ruler may ship an item directly or may use the campaign ruler interface to have the baseless token information processing system 302 ship or facilitate the shipment of the item. The prizes may be selected from the campaign ruler's product line and/or may be selected from a list of products the campaign administrator may arrange to have shipped. For example, a company with very expensive products may choose to have gift cards for commonly needed items delivered to users as a prize. In an example embodiment, a video game manufacturer may provide a new video game as a prize or may provide a promotional baseball cap as a prize. A user may then wear the promotional baseball cap providing an even further marketing reach. Also, in an example embodiment, a prize may be a physical prize (e.g., jewelry, clothing, pizza), a monetary prize (e.g., meal voucher, a poker tournament seat), and/or a virtual prize (e.g., avatar, virtual pet). In an example embodiment, a prize may be an award of a service, which may be provided through a voucher (e.g., a free massage or a free chimney inspection). It should be appreciated that prizes may take a variety of tangible and/or intangible forms, such as a free pizza delivery, which is both a physical pizza and a delivery service.

Finally, a rebate from the rebate account is provided to the campaign ruler for delivery of the prize to the winning user (block 418). For example, a $25 rebate is paid to the advertiser from the rebate account regardless of the number of baseless tokens created and/or destroyed throughout the duration of the campaign. In an example embodiment, a rebate account credits a rebate to a campaign ruler's account, such as an account with the campaign administrator or an account with a third party financial institution. In an example embodiment, if a campaign ruler is engaged in a long term campaign which requires monthly payments, a rebate may be credited directly towards a next monthly payment. In an example embodiment, if a rebate is not provided from a rebate account to the campaign ruler for a specified period of time, the rebate may expire or be reduced. It should be appreciated that the baseless token information processing system 302 provides value to users by, for example, providing or facilitating events that the user may participate in by redeeming baseless tokens to participate. However, if events such as auctions, games, or contests were not offered for users to participate in, there cannot be any winning users. Accordingly, campaign rulers may be incentivized to allow qualifying interactions that meet the rules for destruction to occur, so that delivery of prizes will occur and that rebates may be provided to the campaign ruler. Thus, rebates may be reduced or expire if campaign rulers fail to deliver prizes in a timely fashion. Further, for example, if a prize is delivered which is defective or not the prize which was supposed to be delivered, a rebate will not be provided to the campaign ruler. If a campaign ruler misrepresents a prize, for example, by stating it has a retail value higher than the actual retail value, the campaign ruler may be blacklisted, fined, or the like, so that campaign rulers fairly provide prizes according to the terms of the purchased campaign.

As discussed above, a rebate amount allocated to a rebate account may diminish or expire after a period of time, however, in an example embodiment, baseless tokens may never expire. For example, a baseless token may not be a liability to any user of the baseless token information processing system 302, specifically, a campaign ruler or a campaign administrator, because the campaign administrator is not obligated to provide any prizes to users and campaign rulers are not obligated to provide prizes, but rather, campaign rulers can obtain a rebate allocated in the rebate account for providing prizes. Typically, a campaign ruler would prefer to provide a retail product which may include a profit margin and to be paid the retail value of the product. However, the campaign ruler is not obligated to provide the prize in exchange for the rebate. Also, a rebate allocated may take into account a delivery price. For example, a campaign ruler may provide a $20 retail product which has a $5 delivery cost, in order to receive a $25 rebate. Further, in an example embodiment, rebates may be limited based on a delivery location of a prize. For example, an auction which has a sports jersey available as a prize, which is available for delivery in Great Britain may be limited in delivery options outside of Great Britain, or in rebate provided for delivery outside of Great Britain, based on tax implications, delivery fees, customs, or other issues which may arise. In an example embodiment, baseless tokens can be collected by users located anywhere, but auctions, games, and contests may only be participated in regionally.

In an example embodiment, a baseless token may be redeemable through a right of participation in an event, but not through a right of redemption according to a predetermined exchange schedule. For example, a number of baseless tokens (e.g., 30) may be used to bid on a pair of shoes, but may not be exchanged for the pair of shoes according to a predetermined schedule which prices the shoes at 30 tokens. When baseless tokens only have a right of participation and not a right of redemption, the number of baseless tokens that a single user has, or that all the users of the system collectively have, may not imply any liability. Providing baseless tokens may not provide too much reward to a user for interactions, but rather, may advantageously provide a marginal incentive to users to perform the desired interactions.

Pricing of campaigns may vary based on a variety of factors, including how many baseless tokens per interaction, and thus, how much potential user incentive may be provided for interactions. Increasing the tokens awarded for a given interaction may increase the price for that interaction. For example, a page load campaign which awards one token for a page load may cost $10, while increasing the award to two tokens per page load may cost $18. In an example embodiment, a small website with light traffic, such as 100 hits per day may pay $30 for a one week campaign, while a larger website with heavier traffic, such as 10,000 hits per day, may pay only $5 for the same campaign. For example, an jewelry store with light website traffic may pay a higher total cost than a clothing store with heavy website traffic, even though the number of baseless tokens awarded to clothing store users that take a journey based on the clothing campaign may be significantly higher than the number of baseless tokens awarded to the jewelry store users that take a journey based on the jewelry campaign. The jewelry store may increase its website traffic significantly while the clothing store may increase its website traffic at a lower percentage than the jewelry store.

While it may seem counterintuitive to charge a smaller low traffic website a higher price than a bigger higher traffic website, the benefits to the smaller and larger websites may not correlate to the number of baseless tokens awarded. For example, if the baseless token information processing system 302 has 1,000,000 users and a small website typically gets 100 hits per day, the number of users that complete the interaction at the small website may be hundreds or thousands. However, for a website that typically gets 10,000,000 hits per day, the number of users the system sends to the website could only be a 10% increase at most. While the actual number of new users which complete the journey at the larger website (e.g., 300,000) may be higher than the actual number of new users which complete the journey at the smaller website (e.g., 15,000), a percentage increase in users may be more important than a total number of users. For example, the larger website may value a 3% increase in page loads less than the smaller website values a 15,000% increase in page loads. Moreover, many different campaign rulers may value user interactions differently from each other. Accordingly, the price of a campaign and the number of baseless tokens awarded based on the campaign do not necessarily correlate, and any correlation or lack thereof may be based, at least in part, on the relative sizes of the system user-base and the popularity of the campaign content, typically provided via the campaign ruler's website. Accordingly, it should be appreciated that if users could exchange the tokens awarded to them based on a predetermined exchange schedule, a liability may be associated with the outstanding balance of tokens, which would not be baseless.

In an example embodiment, for a given campaign, a pricing schedule may provide a parameter of typical page views for a website and an associated price (e.g., 100 hits˜$100; 1,000 hits˜$40; 10,000 hits˜$16; 100,000 hits˜$6). Also, the present number of baseless token information processing system 302 users, the user-base, may affect the pricing. For example, for a given campaign, as the user-base increases, the price also may increase in kind (e.g., 1,000 users˜$3; 10,000 users˜$6; 100,000 users˜$16; 1,000,000 users˜$40; 10,000,000 users˜$100). Accordingly, the campaign administrator may benefit greatly from system growth. In an example embodiment, as the base of system users grows, the value provided to campaign rulers increases, which results in higher campaign prices, which in turn results in more prizes and/or better prizes. Thus, the baseless token information processing system 302 may desirably sustain growth of a user-base and campaign rulers through better campaign values and better rewards.

A variety of reporting and analytics may be provided after a campaign ends and/or during an active campaign. For example, graphs, trends, forecasts, recommendations, and success analysis may be provided for standard campaigns. Customized analytics may also be available, for example, if the campaign ruler pays for a customized report. Campaign success may be measured with a variety of statistics and/or metrics. For example, for a given campaign such as a user-base of 10,000, typical website hits of 1,000 per day, with a page load interaction awarding one baseless token, if 35% of the user-base performs the qualifying interaction, the campaign may be considered successful. A successful user-base conversion percentage may typically be 25% or 35%, however, in a given case, expectations for success may be significantly higher or lower. Also, success may be measured in other terms, such as a percentage increase in website traffic of an advertiser, however, what may be considered successful for such a measure may vary greatly depending on various circumstances of the campaign. Similarly, a total number of user interactions, journeys completed, and/or baseless tokens awarded may be used for analysis. It should be appreciated that terms and pricing of future campaigns may be determined based on the success of past campaigns. For example, pricing may be adjusted up or down, awards of baseless tokens may be adjusted up or down, or the like.

In an example embodiment, as a user-base grows, an acceptable user-base conversion percentage decreases, and vice versa. In an example embodiment, as a website's normal traffic increases, an acceptable user-base conversion percentage increases. These exemplary guidelines may or may not apply in a situation, as each campaign may present unique characteristics which may apply. Accordingly, analytics and reporting may provide insights which allow a campaign administrator to optimize pricing, baseless token award levels for interactions, rebate levels, etc. Similarly, such data may allow a campaign ruler to evaluate the baseless token information processing system 302, generation of user journeys, the cost paid per completed journey or user interaction for different campaigns, etc. The campaign ruler may compare the cost effectiveness of a campaign to other marketing channels to validate the value of the campaigns available through the baseless token information processing system 302.

As discussed above, special campaign terms and pricing may be provided for a wide variety of situations. For example, an automobile manufacturer may wish to purchase a large campaign which will generate a palpable buzz among automobile consumers. In this example, the automobile manufacturer may wish to negotiate special terms with the campaign administrator for the campaign. For example, the automobile manufacturer may have a budget of $60,000 to spend, but may want special rebate terms to receive a full rebate for a new car worth $30,000 to be auctioned off as a prize to promote the new car model. Typically, the rebate may be 25%, which would only be a rebate of $15,000. The automobile manufacturer believes that this auction will generate buzz, not only for the new car model, but also for the campaign administrator and the baseless token information processing system 302. It would be expected that consumers which were not already users of the baseless token information processing system 302 will hear of the auction for the new car, and become users of the baseless token information processing system 302. Accordingly, the campaign administrator may provide special terms to accommodate the automobile manufacturer while also promoting the baseless token information processing system 302. A rebate allocation may be significantly greater than the standard pricing terms would, for example, 50% rather than 25%, so a $30,000 rebate allocation allows the automobile to be auctioned off for baseless tokens and a full rebate of $30,000 following delivery of the new car to the winning bidder. Accordingly, the presently disclosed system provides great benefits which may be provided to the campaign administrator, the campaign ruler (e.g., the automobile manufacturer), and the users of the baseless token information processing system 302, by promoting the baseless token information processing system 302, promoting the new car model through the created user interactions, and receiving a new car, respectively.

In an example embodiment, an offer for a free campaign may be provided from a campaign administrator to a prospective campaign ruler. For example, a free campaign which would cost $10 may be provided to an advertiser. The advertiser cost is $0 with a $0 rebate allocation. A report of user interactions may then be provided to illustrate the effectiveness of the campaign to get the campaign ruler to purchase further campaigns. Similarly, atypical rebate percentages may be used, including 0% of the campaign cost, or 100% of a campaign cost. The campaign administrator may have wide latitude to fashion campaigns to suit the needs of the baseless token information processing system 302, the campaign administrator, campaign rulers, and/or users with any given campaign.

In an example embodiment, the baseless token information processing system 302 has a baseless token account or ledger which may be provided with a starting balance of baseless tokens by a campaign administrator. In an example embodiment, a campaign administrator may start with one trillion baseless tokens. When a user performs a qualifying interaction according to a campaign ruler's rules for creation, a token from the account may be awarded to the user account. When a user performs a qualifying interaction according to a campaign ruler's rules for destruction, a token may be removed from the user account, and may be added to the baseless token information processing system 302 baseless token account balance or ledger. Moreover, in the present disclosure, no distinction is made for whether a balance of baseless tokens is maintained or not maintained, and if so, whether it may start at zero or some other number, because the baseless tokens are baseless. For example, if a baseless token information processing system 302 maintains a balance of baseless tokens, and the balance reaches zero tokens, more baseless tokens may be generated. Accordingly, any numerical balance of baseless tokens is not pertinent to whether the tokens are baseless tokens. Similarly, in the present disclosure, awarding baseless tokens created at the time of a user interaction may be indistinguishable from awarding baseless tokens which were created at a time prior to the user interaction, as the time of creation of the baseless token is irrelevant. Likewise, in the present disclosure, removing baseless tokens from a user account to some ledger or other account following a user interaction may be indistinguishable from destroying baseless tokens following a user interaction. For example, the baseless token information processing system 302 may destroy a first token A and then create a second token B, which may provide the same function as removing token A and then providing token A instead of B, because the tokens A and B are both baseless tokens, and are thus, the same.

It should be appreciated that in the present disclosure, a single campaign administrator or a single campaign ruler may be referred to by way of example, but that multiple campaign administrators and multiple campaign rulers may exist, for example several marketing companies may be campaign administrators, each of which may serve many campaign rulers. Also, although a typical auction, contest, or game may have several users participating, a single user may participate. For example, a user may bid on an auction item and win the auction by placing a single bid of one baseless token.

Accordingly, it should be appreciated that users, campaign rulers, and campaign administrators, may receive significant benefits from the method of facilitating a user interaction using baseless tokens disclosed herein. In an example embodiment, the baseless tokens provide a user with a marginal incentive to interact with the campaign ruler. Moreover, inefficiencies in the marketing industry may be minimized by utilizing the presently disclosed system and method to provide marginal incentives to users.

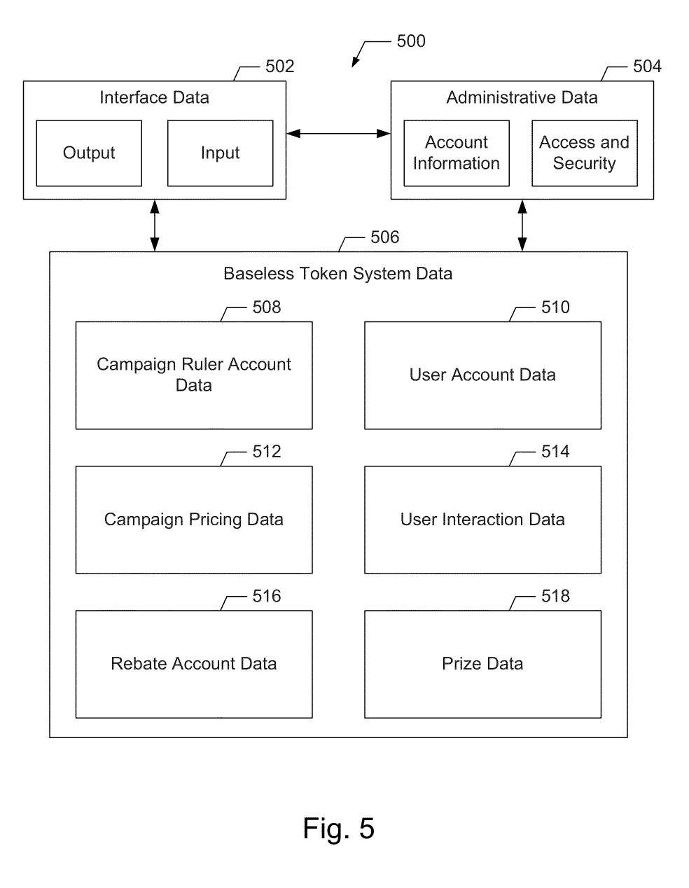

FIG. 5 illustrates a block diagram of an example data architecture 500. In the example data architecture 500, interface data 502, administrative data 504, and baseless token system data 506 interact with each other, for example, based on user interactions, commands or requests. The interface data 502, administrative data 504, and baseless token system data 506 may be stored on any suitable storage medium (e.g., server 226). It should be appreciated that different types of data may use different data formats, storage mechanisms, etc. Further, various applications may be associated with processing interface data 502, administrative data 504, and baseless token system data 506. Various other or different types of data may be included in the example data architecture 500.

Interface data 502 may include input and output data of various kinds. For example, input data may include mouse click data, scrolling data, hover data, keyboard data, touch screen data, voice recognition data, etc., while output data may include image data, text data, video data, audio data, etc. Interface data 502 may include formatting, user interface options, links or access to other websites or applications, and the like. Interface data 502 may include applications used to provide or monitor interface activities and handle input and output data. As discussed above, in an example embodiment, a browser application 312 may be specifically provided for managing interface data 502 for the user interface 308.

Administrative data 504 may include data and applications regarding user 114 accounts. For example, administrative data 504 may include information used for updating accounts, such as creating or modifying campaign ruler accounts or user accounts. Further, administrative data 504 may include system administration data, access data, and/or security data. Administrative data 504 may include a terms of service agreement. Administrative data 504 may interact with interface data in various manners, providing a user interface 304, 306, 308 with administrative features, such as implementing a user login, confirming user data, and the like.

Baseless token system data 506 may include, for example, campaign ruler account data 508, user account data 510, campaign pricing data 512, user interaction data 514, rebate account data 516, prize data 518. Campaign ruler account data 508 may include data including account balances, bank account information, and the like. User account data 510 may include information on individual users 114 including a home or shipping address, device identification data, etc., and aggregated data relating to the total number of users 114, and characteristics such as high activity levels or low activity levels for groups of users 114. Campaign pricing data 512 may include standard campaign pricing, negotiated prices for large scale campaigns, campaign pricing success data, etc. User interaction data 514 may include information on specific users as well as aggregate information, including user interactions of different types, repeat and unique interaction information, baseless token user account balances, baseless tokens created and/or destroyed, user journey activity, user participation activity, user search activity, user feedback, etc. Rebate account data 516 may include data for campaign rebate allocations, rebate balances, rebate adjustments, etc., for individual campaigns and/or campaign rulers, as well as for aggregated and historical rebate data. Prize data 518 may include data on prizes currently available, prizes awarded, various statistics relating to prizes based on participation, etc.

The various baseless token system data 506 may be used for providing reports including graphs, trends, forecasts, recommendations, success analysis, etc. Various standard or custom analytics may be provided, for example, to campaign rulers upon request. It should be appreciated that certain data may fall under one or more categories of baseless token system data 506. Baseless token system data 506 may be maintained in various servers 108, in databases or other files. It should be appreciated that, for example, a host device 104 may manipulate baseless token system data 506 in accordance with the administrative data 504 and interface data 502 to provide baseless tokens, account information, rebates, and/or reports to users 114 including a campaign administrator, campaign rulers, and/or users and perform other associated tasks. For example, a campaign administrator may run a report on a number of created baseless tokens or the balance of currently outstanding baseless tokens among all users, which may provide insight into campaign effectiveness and/or user behavior, be useful for adjusting campaign strategies and pricing, and the like.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
facilitating a purchase of a campaign by a campaign ruler from a campaign administrator, wherein a campaign purchase cost includes a rebate amount which is allocated to a rebate account;
receiving inputs indicating a set of rules for creation from the campaign ruler, the set of rules for creation defining a first qualifying user interaction and a corresponding award of baseless tokens, wherein the first qualifying user interaction includes at least one digital interaction, wherein a plurality of users are capable of performing the first qualifying user interaction;
receiving inputs indicating a set of rules for destruction from the campaign ruler, the set of rules for destruction defining a second qualifying user interaction and a corresponding destruction of baseless tokens, wherein the second qualifying user interaction includes participation in at least one of an auction, a contest, and a game, wherein the plurality of users are capable of performing the second qualifying user interaction;
awarding to at least a first user of the plurality of users at least one baseless token created in response to the user performing the first qualifying user interaction on a first user device, wherein the at least one baseless token is redeemable only through a right of participation in an event and is without a right of redemption according to a predetermined exchange schedule;
destroying at least one baseless token in response to at least one of the plurality of users performing the second qualifying user interaction on a second user device, wherein the right of participation is only available through redemption of baseless tokens;
facilitating delivery of a prize to a winning user of the at least one of the auction, the contest, and the game; and
providing a rebate from the rebate account to the campaign ruler for delivery of the prize to the winning user, wherein the rebate account is maintained independently of the number of baseless tokens created and the number of baseless tokens destroyed.

2. The method of claim 1, further comprising:
providing users with a browser application which is at least configured to:
detect qualifying user interactions; and
provide baseless token information to the users including at least information regarding the first user interaction and the users' baseless token balance.

3. The method of claim 2, wherein the browser application provides a baseless token icon that indicates to the users that baseless tokens are available to be awarded for user interactions at a website that is provided as an internet search result.

4. The method of claim 1, wherein the first qualifying user interaction is at least one of a page load, a referral load, a purchase, a subscription, a sign-up, a survey completion, a video completion, a download, a vote, a check-in, a drop down selection, a link click, and a button click.

5. The method of claim 1, wherein the prize is one of a physical prize, a virtual prize, and a monetary prize.

6. The method of claim 1, wherein the prize is a retail product sold by the campaign ruler.

7. The method of claim 1, wherein the winning user is the first user.

8. The method of claim 1, wherein the at least one of the auction, the contest, and the game produces at least two winning users.

9. The method of claim 8, wherein the at least two winning users are determined by at least one of the top scores, the fastest times, and the highest bids.

10. The method of claim 1, wherein the first user device is the second user device.

11. The method of claim 1, wherein a plurality of campaign rulers each engage in at least one campaign, each of which includes a set of rules for creation of baseless tokens and a set of rules for destruction of baseless tokens.

12. The method of claim 1, wherein the campaign is priced based on at least a number of qualifying user interactions for the rules of creation, a number of baseless tokens awarded for each such user interaction, an expected number of qualifying user interactions to be performed by the plurality of users, a number of the existing plurality of users, and a number of users of the campaign ruler website, and a duration of the campaign.

13. The method of claim 1, wherein the rebate provided is the full rebate amount allocated to the rebate account.

14. The method of claim 1, wherein baseless tokens never expire and the rebate amount allocated to a rebate account will at least one of diminish and expire after a period of time.

15. The method of claim 1, wherein the campaign administrator provides baseless tokens to users for self promotion.

16. The method of claim 1, wherein the campaign administrator provides a campaign to a campaign ruler for free with a campaign purchase cost of zero and a rebate amount of zero.

17. A system comprising:
a computer readable medium storing campaign information including sets of rules for creation of baseless tokens and sets of rules for destruction of baseless tokens;
at least one processing device operably coupled to the computer readable medium, the at least one processing device executing instructions to:
facilitate a purchase of a campaign by a campaign ruler from a campaign administrator, wherein a campaign purchase cost includes a rebate amount which is allocated to a rebate account;
receive inputs indicating a set of rules for creation from the campaign ruler, the set of rules for creation defining a first qualifying user interaction and a corresponding award of baseless tokens, wherein the first qualifying user interaction includes at least one digital interaction, wherein a plurality of users are capable of performing the first qualifying user interaction;
receive inputs indicating a set of rules for destruction from the campaign ruler, the set of rules for destruction defining a second qualifying user interaction and a corresponding destruction of baseless tokens, wherein the second qualifying user interaction includes participation in at least one of an auction, a contest, and a game, wherein the plurality of users are capable of performing the second qualifying user interaction;
award to at least a first user of the plurality of users at least one baseless token created in response to the user performing the first qualifying user interaction on a first user device, wherein the at least one baseless token is redeemable only through a right of participation in an event and is without a right of redemption according to a predetermined exchange schedule;
destroy at least one baseless token in response to at least one of the plurality of users performing the second qualifying user interaction on a second user device, wherein the right of participation is only available through redemption of baseless tokens;
facilitate delivery of a prize to a winning user of the at least one of the auction, the contest, and the game; and
provide a rebate from the rebate account to the campaign ruler for delivery of the prize to the winning user, wherein the rebate account is maintained independently of the number of baseless tokens created and the number of baseless tokens destroyed.

18. A method comprising:
purchasing a campaign from a campaign administrator via a campaign ruler interface, wherein a campaign purchase cost includes a rebate amount which is allocated to a rebate account;
providing inputs indicating a set of rules for creation via a campaign ruler interface, the set of rules for creation defining a first qualifying user interaction and a corresponding award of baseless tokens, wherein the first qualifying user interaction includes at least one digital interaction, wherein a plurality of users are capable of performing the first qualifying user interaction;
providing inputs indicating a set of rules for destruction via a campaign ruler interface, the set of rules for destruction defining a second qualifying user interaction and a corresponding destruction of baseless tokens, wherein the second qualifying user interaction includes participation in at least one of an auction, a contest, and a game, wherein the plurality of users are capable of performing the second qualifying user interaction;
facilitating the campaign administrator with awarding to at least a first user of the plurality of users at least one baseless token created in response to the user performing the first qualifying user interaction on a first user device, wherein the at least one baseless token is redeemable only through a right of participation in an event and is without a right of redemption according to a predetermined exchange schedule;
facilitating the campaign administrator with destroying at least one baseless token in response to at least one of the plurality of users performing the second qualifying user interaction on a second user device, wherein the right of participation is only available through redemption of baseless tokens;
delivering a prize to a winning user of the at least one of the auction, the contest, and the game; and
receiving a rebate from the rebate account from the campaign administrator for delivery of the prize to the winning user, wherein the rebate account is maintained independently of the number of baseless tokens created and the number of baseless tokens destroyed.

19. A system comprising:
a computer readable medium storing campaign information including at least one set of rules for creation of baseless tokens and at least one set of rules for destruction of baseless tokens;
at least one processing device operably coupled to the computer readable medium, the at least one processing device executing instructions to:
purchase a campaign from a campaign administrator via a campaign ruler interface, wherein a campaign purchase cost includes a rebate amount which is allocated to a rebate account;
provide inputs indicating a set of rules for creation via a campaign ruler interface, the set of rules for creation defining a first qualifying user interaction and a corresponding award of baseless tokens, wherein the first qualifying user interaction includes at least one digital interaction, wherein a plurality of users are capable of performing the first qualifying user interaction;
provide inputs indicating a set of rules for destruction via a campaign ruler interface, the set of rules for destruction defining a second qualifying user interaction and a corresponding destruction of baseless tokens, wherein the second qualifying user interaction includes participation in at least one of an auction, a contest, and a game, wherein the plurality of users are capable of performing the second qualifying user interaction;
facilitate the campaign administrator with awarding to at least a first user of the plurality of users at least one baseless token created in response to the user performing the first qualifying user interaction on a first user device, wherein the at least one baseless token is redeemable only through a right of participation in an event and is without a right of redemption according to a predetermined exchange schedule;
facilitate the campaign administrator with destroying at least one baseless token in response to at least one of the plurality of users performing the second qualifying user interaction on a second user device, wherein the right of participation is only available through redemption of baseless tokens;
deliver a prize to a winning user of the at least one of the auction, the contest, and the game; and
receive a rebate from the rebate account from the campaign administrator for delivery of the prize to the winning user, wherein the rebate account is maintained independently of the number of baseless tokens created and the number of baseless tokens destroyed.
